(19) United States
(12) Patent Application Publication
(10) Pub. No.: US 2003/0190574 A1
(43) Pub. Date: Oct. 9, 2003

(54) Apparatus for transporting substrates in an oven

(76) Inventors: Reto Schmid, (US); Guido Suter, (US)

Correspondence Address: David B. Ritchie, Thelen Reid & Priest LLP, P.O. Box 640640, San Jose, CA, 95164-0640, US

(21) Appl. No.: 10/390,203

(22) Filed: Mar. 14, 2003

(30) Foreign Application Priority Data
Apr. 3, 2002 (CH) 2002 0565/02

(51) Int. Cl. F27D 3/04

(52) U.S. Cl. 432/121; 432/126

(57) ABSTRACT

The invention concerns a transport apparatus for transporting substrates in an oven. The oven has a channel formed from a floor and two side walls in which the substrates are transported in a transport direction. The floor of the channel has a recess running along one of the side walls for accepting and guiding a rail in transport direction. The rail is set up for accepting at least one substrate. A drive mechanism moves the rail in transport direction.

### PRIORITY CLAIM

The present application claims priority under 35 U.S.C § 119 based upon Swiss Patent Application No. 2002 0565/02 filed on Apr. 3, 2002.

### FIELD OF THE INVENTION

The invention concerns an apparatus for transporting substrates in an oven.

### BACKGROUND OF THE INVENTION

With the mounting of semiconductor chips, it is common to connect the semiconductor chips, mainly power semiconductors, to the substrate by means of soft solder in order to guarantee an effective dissipation of the heat-loss occurring from the semiconductor chip during operation via the solder connection. Equipping the substrate with the semiconductor chips takes place at relatively high temperatures at which the solder is melted. High demands are therefore placed on the transport apparatus.

Metallic substrates, so-called leadframes, are predominantly used as substrates where the semiconductor chips are soldered onto chip islands arranged one behind the other or, optionally, next to each other. The leadframe is fed in steps to a soldering station where the solder is applied and then to a bonding station where the semiconductor chip is placed onto the liquid solder by a Pick and Place system. The leadframe has holes arranged along its longitudinal edge into which pins engage when transporting the leadframe. A Die Bonder suitable for this process is marketed by the applicant under the designation 2007 SSI.

Single position substrates, so-called singulated substrates, are however also used as substrates. Such a single position substrate consists for example of one ceramic disk which is covered on both sides by a metal layer. Mounting of the semiconductor chips takes place manually whereby initially a preformed solder portion, known as a solder preform, is placed onto the single position substrate and then the semiconductor chip is placed onto the solder portion. Afterwards, the entire composite is soldered in an oven. A semi-automatic assembly process is also known with which instead of a pre-formed solder portion, paste-type solder is mechanically applied to the single position substrate. Afterwards, the single position substrate is equipped manually with the semiconductor chip and again soldered in an oven.

Furthermore, ceramic disks covered on both sides by a metal layer are also used as substrates which are equipped with numerous semiconductor chips of the same or different types. Processing of these substrates takes place manually for small-lot production. Automatic processing is only economical for large amounts as the known transport apparatuses must be designed individually for each substrate.

### BRIEF DESCRIPTION OF THE INVENTION

The object of the invention is to develop a transport apparatus which can be easily set up for the processing of different substrates so that even small lots can be processed to a large extent automatically. In addition, the transport apparatus should also be suitable for individual trials in the laboratory.

With the mounting of semiconductor chips onto a substrate by means of soldering, the substrates are conveyed in an oven to a soldering station where the solder is applied and then to a bonding station where the semiconductor chip is deposited onto the melted solder. In doing so, the substrates are transported in a transport direction in a channel formed from a floor and two side walls. In accordance with the invention, the floor of the channel has a recess running along one of the side walls for accepting and guiding a rail in transport direction. The rail is set up for accepting at least one substrate. A drive mechanism moves the rail in transport direction. When the substrate is a leadframe, then the leadframe can be screwed to the rail or secured by clamping. For the transport of ceramic substrates, extension arms running at right angles to the transport direction which accept the ceramic substrate can be mounted onto the rail.

### BRIEF DESCRIPTION OF THE DRAWING FIGURES

The accompanying drawings, which are incorporated into and constitute a part of this specification, illustrate one or more embodiments of the present invention and, together with the detailed description, serve to explain the principles and implementations of the invention. The figures are not to scale.

In the drawings:

FIG. 1 shows a plan view of a Die Bonder with an oven with a transport apparatus,

FIG. 2 shows a cross-section of the oven and the transport apparatus along the line I-I of FIG. 1,

FIG. 3 shows a side view of a rail,

FIG. 4 shows a plan view of the rail and a leadframe,

FIG. 5 shows a rail with extension arms for transporting ceramic substrates,

FIG. 6 shows a section of the extension arms and a ceramic substrate along the line II-II of FIG. 5,

FIG. 7 shows a further example of the interaction of the extension arms with the ceramic substrate.

### DETAILED DESCRIPTION OF THE INVENTION

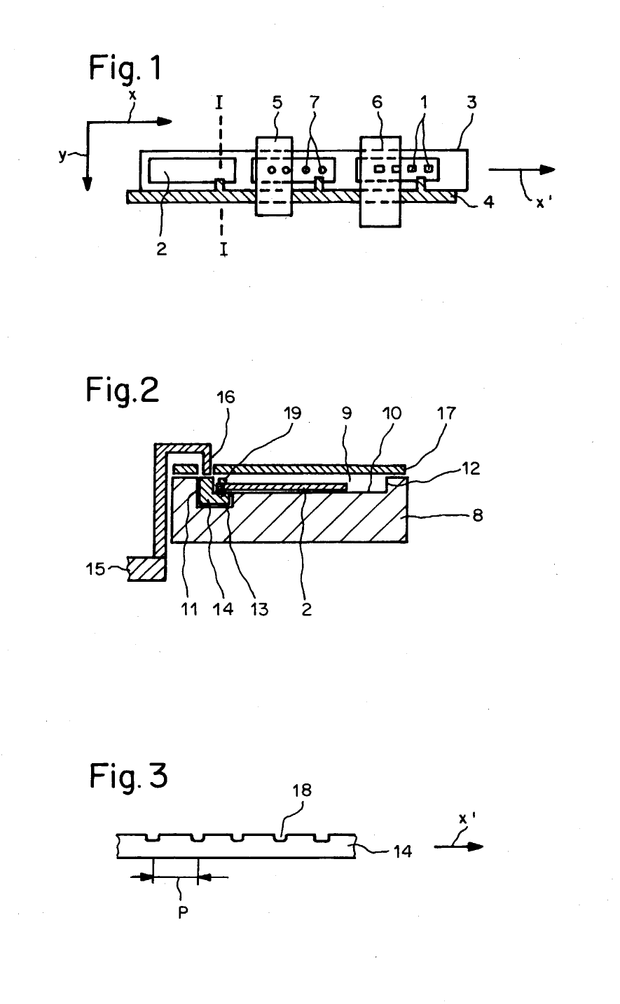

FIG. 1 shows schematically a plan view of a Die Bonder for the soldering of semiconductor chips 1 onto substrates 2. The Die Bonder comprises an oven 3 moveable in two horizontal directions x and y with a transport apparatus 4 for forward feed of the substrates 2 in a transport direction x′, a soldering station 5 and a bonding station 6. The transport direction x′ runs parallel to the direction x. The soldering station 5 serves to apply a solder portion 7 to the substrate position presented at the soldering station, the bonding station 6 serves to place a semiconductor chip 1 onto the substrate location presented at the bonding station 6. In the drawing, the solder portions 7 are presented as circles for purely illustrative reasons while the semiconductor chips 1 are drawn as rectangles. The substrates 2 are supplied manually or automatically one after the other and transported in steps by the transport apparatus 4 through the oven 3 in transport direction x′. With each step, the substrates 2 are transported further by a predefined distance P known as the pitch. A predefined temperature profile is produced in the oven 3 by not presented means. The distance between the process point of the soldering station 5 and the process point of the bonding station 6 amounts to an integral multiple of the distance P so that simultaneously a solder portion 7 can be applied at the soldering station 5 and a semiconductor chip 1 can be deposited at the bonding station 6.

On the one hand, there are substrates 2 with which only one semiconductor chip 1 is applied per forward feed by the distance P. On the other hand, there are substrates 2 with which several semiconductor chips 1 are applied per forward feed by the distance P. With these substrates the oven 3 is moved together with the transport apparatus 4 in x and/or y direction in order to correctly position the substrates 2 in relation to the soldering station 5 and the bonding station 6.

FIG. 2 shows the details of the oven 3 and the transport apparatus 4 relevant for the understanding of the invention. FIG. 2 is a sectional drawing along the line I-I of FIG. 1. The oven 3 has an oven body 8 with a channel 9 with a flat floor 10 and two side walls 11 and 12 in which the substrates 2 are transported forwards. The channel 9 has a recess 13 in the floor 10 which runs along the first side wall 11. The recess 13 serves as a guide slot for guiding a, for example L-shaped, rail 14. The rail 14 accepts a substrate 2 or several substrates 2. The transport apparatus 4 comprises a drive mechanism 15 which has several fingers 16 arranged at an integral multiple of the distance P which can be raised and lowered and which, in the lowered condition, transport the rail 14 in steps in transport direction x′, whereby the rail 14 is guided in the recess 13. The channel 9 is covered by a cover plate 17. The cover plate 17 does not actually touch the rail 14 but prevents the rail 14 from possibly jumping out of the recess 13. The cover plate 17 has openings for the fingers 16.

Generally an inert gas atmosphere predominates in the channel 9. The inert gas can be supplied as is usual in the prior art, eg, through drill holes provided in the floor 10 of the channel 9.

FIG. 3 shows a side view of the rail 14. The rail 14 has recesses 18 arranged at distance P. For the forward feed of the rail 14, the fingers 16 (FIG. 2) of the transport apparatus 4 are lowered so that they each engage into one of the recesses 18 of the rail 14.

In the example in FIG. 2, the substrate 2 is a metallic leadframe. Generally, such leadframes consist of copper. The rail 14 is manufactured from a chromium steel which has the same thermal coefficient of expansion as the leadframe. The leadframe can be secured to the rail 14 in various ways, for example by means of one single screw 19. On heating and cooling in the oven 3 the lengths of the rail 14 and the leadframe change at differing speeds. Attachment by means of one single screw 19 guarantees that, on heating and cooling, the leadframe remains free of mechanical stresses.

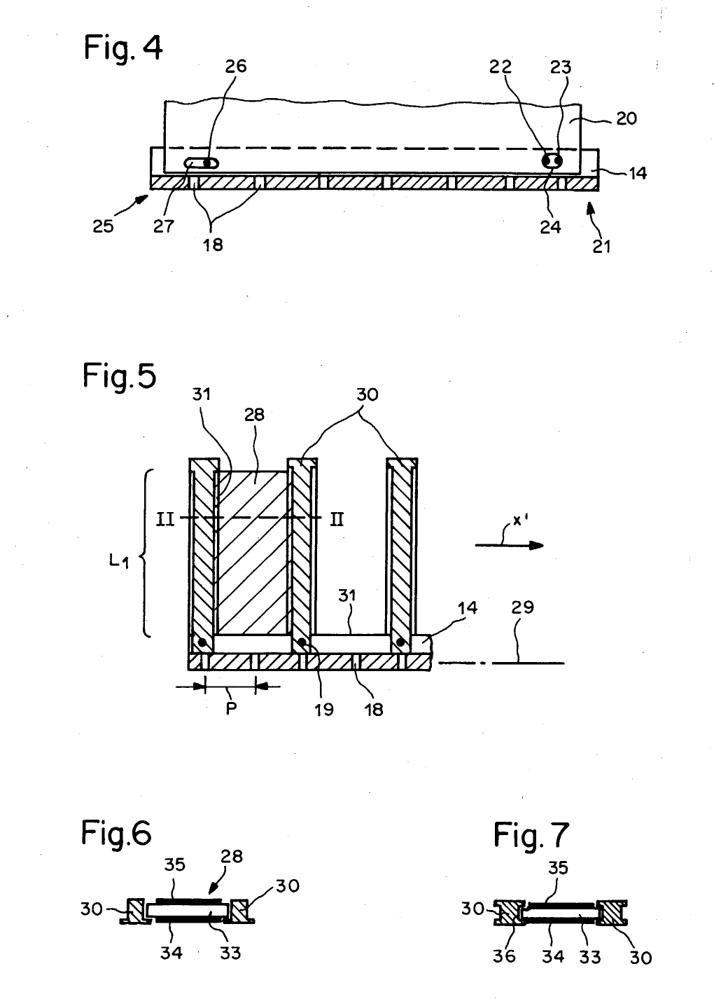

FIG. 4 shows a plan view of a solution with which the leadframe 20 is secured to the rail 14 by clamping. The inner structures of the leadframe 20 are not drawn. The rail 14 has, for example, two bolts 22 and 23 at its front end 21. Their distance is dimensioned so that the leadframe 20 is held by clamping when the bolts 22 and 23 engage in a hole 24 in the leadframe 20. The leadframe 20 is typically around 20 cm long. Therefore, it is of advantage when the rail 14 has a further bolt 26 at its rear end 25 which engages in an additional, preferably longitudinal hole 27 in the leadframe 20. The bolt 26 does not serve to clamp the leadframe 20 but only to guide it so that its longitudinal edge rests on the rail 14.

In the event that the pitch of the leadframe does not coincide with the pitch of the transport apparatus, then the leadframe can be separated into smaller individual parts. Several such individual parts can then be secured to one rail 14.

The outer shape of the rail 14 can be easily adapted to the leadframe. There are leadframes which, on the one hand, are completely flat, on the other hand there are leadframes the longitudinal edge of which is higher or lower in relation to the middle.

FIG. 5 shows an embodiment of the rail 14 suitable for ceramic substrates 28. The rail 14 has extension arms 30 running at right angles to its longitudinal axis 29 which are arranged at the distance P or at an integral multiple of the distance P. The extension arms 30 can be formed in many different ways. Together with the rail 14, their task exists in accepting the ceramic substrates 28 in a defined position and to transport them in transport direction x′. With the example presented in FIG. 5, the extensions arms 30 have recesses 31 running along the edge. The length L₁ of the recesses 31 is dimensioned so that the ceramic substrates 28 can be placed inside from above and rest on a side wall 32 of the rail 14. During transport, the ceramic substrates 28 rest on the extension arms 30 and, optionally, on the rail 14. The form of the extension arms 30 with the recesses 31 prevents the ceramic substrates 28 from sliding away. The width of the extension arms 30 is adapted to the width of the ceramic substrates 28 and the distance P. The extension arms are, for example, secured to the rail 14 with screws 19. In the example, the distance between two extension arms 30 amounts to twice the pitch distance P.

FIG. 6 shows a section along line II-II of FIG. 5 of a ceramic substrate 28 inserted between two extension arms 30. The ceramic substrate 28 has a body 33 made of ceramics which is covered on both sides with metallic layers 34 and 35. The metallic layers 34 and 35 leave one edge of the body 33 uncovered. The recesses 31 and the distance between the extension arms 30 are dimensioned so that only the uncovered edge of the ceramic substrate 28 rests on the extension arms 30. In addition, the thickness of the extension arms 30 in the area of the recesses 31 is selected as the same thickness as the metallic layer 34 so that the ceramic substrate 28 rests on the floor 10 (FIG. 2) of the oven 3.

FIG. 7 shows a section of an example analogous to FIG. 6 with which the extension arms 30 have a groove 36 so that the ceramic substrates 28 can be pushed in from the side. The length of the extension arms 30 is dimensioned so that its end edge is flush with the edge of the ceramic substrate 28. A possible gap between the edge of the ceramic substrate 28 and the side wall 12 (FIG. 2) of the oven body 8 is filled by means of a plate so that the ceramic substrates 28 can not slide away in y direction (FIG. 1).

The invention enables the automatic processing of substrates the width of which is less than the width of the channel 9 of the oven 3. In addition, the invention enables the processing of different types of substrate such as metallic substrates and ceramic substrates.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. An apparatus for transporting substrates in an oven, the oven having a channel formed from a floor and two side walls, the substrates being transported in the channel in a transport direction, the floor of the channel having a recess running along one side wall for accepting and guiding a rail in the transport direction, the rail set up for accepting at least one substrate, and the apparatus further comprising a drive mechanism for moving the rail in the transport direction.

2. The apparatus according to claim 1, wherein the rail has a drill hole in order to secure the at least one substrate to the rail by means of a screw.

3. The apparatus according to claim 1, wherein the rail has at least one bolt which engages in a hole in the at least one substrate and securely clamps the substrate.

4. The apparatus according to claim 1, wherein the rail has extension arms which accept the at least one substrate.

5. The apparatus according to claim 1, wherein the rail has recesses in which fingers of the drive mechanism engage during the transport phase.

6. The apparatus according to claim 2, wherein the rail has recesses in which fingers of the drive mechanism engage during the transport phase.

7. The apparatus according to claim 3, wherein the rail has recesses in which fingers of the drive mechanism engage during the transport phase.

8. The apparatus according to claim 4, wherein the rail has recesses in which fingers of the drive mechanism engage during the transport phase.
